(19) United States
(12) Patent Application Publication
(10) Pub. No.: US 2023/0259650 A1
(43) Pub. Date: Aug. 17, 2023

(54) SYSTEM AND METHOD FOR DATA PRIVACY POLICY GENERATION AND IMPLEMENTATION

(71) Applicant: Bornio, Inc., Menlo Park, CA (US)

(72) Inventors: Maryam Sepehri, Waterloo (CA); Patrick Chan, Palo Alto, CA (US); Altamiro Santos, Montreal (CA); Ravi Jagannathan, Dublin, CA (US)

(73) Assignee: Bornio, Inc., Menlo Park, CA (US)

(21) Appl. No.: 18/169,843

(22) Filed: Feb. 15, 2023

Related U.S. Application Data
(60) Provisional application No. 63/311,307, filed on Feb. 17, 2022.

(51) Int. Cl. G06F 21/62; G06F 16/906

(52) U.S. Cl. CPC G06F 21/6227; G06F 16/906

(57) ABSTRACT

Techniques for generating and implementing data privacy policies are described. In an example, metadata associated with a data source is annotated with attributes indicative of the data contained therein and its associated sensitivity. Based on the annotated metadata and the contexts in which the data will be accessed, including the purpose for accessing the data, the role of the accessor, and the location of the accessor, privacy policies are generated from a privacy model. The privacy policies are generated with a collection of methods for protecting the data in the data source upon access. Based on a privacy policy and a target computing environment, an executable instance of the privacy policy is generated and deployed in the target computing environment to protect the data.

### CROSS-REFERENCE TO RELATED APPLICATION

This application claims the benefit of U.S. Provisional No. 63/311,307, filed on Feb. 17, 2022, entitled “SYSTEM AND METHOD FOR DATA PRIVACY POLICY GENERATION AND IMPLEMENTATION,” the entire contents of which are incorporated herein by reference for all purposes.

### BACKGROUND

As the number and variety of data privacy regulations continues to increase globally, companies and organizations may be required to continuously adapt and improve their protection of personal or sensitive data they acquire, store, and/or process. However, as new techniques for analyzing data become available, continuing to leverage such techniques while safeguarding the underlying data may become challenging. Embodiments detailed herein provide effective techniques for generating and implementing privacy policies that enable custodians to leverage their data without compromising its security.

### SUMMARY

Various embodiments are described related to generating and implementing data privacy policies. In some embodiments, a method of generating privacy policies is described. The method may comprise obtaining metadata associated with a data source, raw data from the data source, or both. The metadata may represent an organization of the raw data by the data source into one or more fields. The method may further comprise selecting attributes to describe each field of the one or more fields based on the metadata, the raw data, or both to produce annotated metadata associated with the data source. The method may further comprise determining a context in which the raw data will be accessed from the data source. The method may further comprise generating a privacy policy for protecting access to the raw data in the context by applying a privacy model defined for the context to the annotated metadata.

In some embodiments, the attributes for a field are selected from categories comprising a type category indicating a class of information represented by the raw data stored in the field, a format category indicating how the information is represented in the raw data, and a sensitivity category indicating a degree of sensitivity associated with the information. In some embodiments, one or more of the attributes are selected based on the context in which the raw data will be accessed. In some embodiments, the context comprises a first combination of an intended use of the raw data, a data privacy law or regulation, a functional role of a user who will access the raw data, and a geographical location from which the raw data will be accessed.

Embodiments of such a method may further comprise determining a plurality of potential contexts in which the raw data will be accessed including the context, wherein each context of the plurality of potential contexts comprises a different combination of the intended use, the data privacy law or regulation, the functional role, and the geographical location compared to the first combination, and generating a plurality of privacy policies for each content of the plurality of potential contexts. In some embodiments, the privacy policy comprises protection methods prescribed for each field of the one or more fields for protecting the raw data upon access in the context. In response to accessing the raw data from the data source in the context, the protection methods may automatically transform the raw data into a protected form by either changing values of the raw data, redacting the values of the raw data, or both.

In some embodiments, the method further comprises displaying the data source specific privacy policy to a user and modifying the privacy policy in response to one or more interactions from the user to produce a modified privacy policy. Such a method may further comprise receiving the modified privacy policy and modifying the policy model or the corresponding data source agnostic policy based on differences between the privacy policy and the modified privacy policy.

In some embodiments, the data source is included in a target environment and the method further comprises generating an executable privacy filter based on the privacy policy and the target environment, deploying the executable privacy filter within the target environment, receiving a request for a subset of the raw data in the data source, and dynamically retrieving, by the executable privacy filter, the subset of the raw data in a protected form in response to receiving the request. In some embodiments, the executable privacy filter persists the raw data in the protected form in the target environment. The target environment may be a database, a file, an object store, or a combination of a database, a file, and an object store.

In some embodiments, a method of deploying a privacy filter in a target environment is described. The method may comprise selecting a first privacy policy from a plurality of privacy policies generated for protecting raw data in a data source. The method may further comprise generating a definition for a target computing environment based on details obtained for a computing environment comprising the data source. The method may further comprise generating, based on the definition, an executable instance of the first privacy policy for the target computing environment. The method may further comprise deploying the executable instance of the first privacy policy within the target computing environment.

In some embodiments, the executable instance of the first privacy policy is configured to transform the raw data into a protected form in response to a request to access the raw data in the data source. Such a method may further comprise monitoring a transformation of the raw data into the protected form by the executable instance of the first privacy policy to produce protected data and detecting an anomaly in the transformation based on the protected data.

In some embodiments, each privacy policy of the plurality of privacy policies is generated for a corresponding context of a plurality of contexts in which the raw data will be accessed and the method further comprises generating a plurality of executable instances for each privacy policy of the plurality of privacy policies. In some embodiments, the executable instance of the first privacy policy is selected from the plurality of executable instances in response to a request to access the raw data in the data source from a client program with a context that corresponds to the first privacy policy. In some embodiments, the executable instance of the first privacy policy comprises one or more transformation functions configured to transform a raw value in a field of the raw data by either changing the raw value to a new value, redacting the raw value, or both.

In some embodiments, the definition for the target computing environment comprises information about the data source, a transformed data source, a processing resource by which the executable instance will be executed, and an intended form of the executable instance. In some embodiments, the method further comprises generating, based on a second definition for a second target computing environment, a second executable instance of the first privacy policy, and deploying the second executable instance of the first privacy policy within the second target computing environment.

### BRIEF DESCRIPTION OF THE DRAWINGS

The accompanying drawings, which are included to provide a further understanding of the disclosure, are incorporated in and constitute a part of this specification, illustrate embodiments of the disclosure and together with the detailed description serve to explain the principles of the disclosure. No attempt is made to show structural details of the disclosure in more detail than may be necessary for a fundamental understanding of the disclosure and various ways in which it may be practiced.

FIG. 1 illustrates a data privacy system configured to generate data privacy policies and data privacy filters according to some embodiments.

FIG. 2 illustrates a data privacy system configured to annotate private data according to some embodiments.

FIG. 3 illustrates a data privacy system configured to generate context-based data privacy policies according to some embodiments.

FIG. 4 illustrates the implementation and deployment of privacy policy based executable data privacy filters in a target environment according to some embodiments.

FIG. 5 illustrates an exemplary method of generating context-based data privacy policies according to some embodiments.

FIG. 6 illustrates an exemplary method of deploying and implementing policy-based data privacy filters according to some embodiments.

FIG. 7 illustrates a block diagram of an embodiment of a computer system according to some embodiments.

In the appended figures, similar components and/or features may have the same reference label. Further, various components of the same type may be distinguished by following the reference label by a dash and a second label that distinguished among the similar components. If only the first reference label is used in the specification, the description is applicable to any one of the similar components having the same first reference label irrespective of the second reference label.

### DETAILED DESCRIPTION

The ensuing description provides preferred exemplary embodiment(s) only, and is not intended to limit the scope, applicability, or configuration of the disclosure. Rather, the ensuing description of the preferred exemplary embodiment(s) will provide those skilled in the art with an enabling description for implementing a preferred exemplary embodiment. It is understood that various changes may be made in the function and arrangement of elements without departing from the spirit and scope as set forth in the appended claims.

The emergence of public data clouds and the growing number of data privacy regulations globally may require companies and organizations to better protect personal, sensitive data they acquire, store, and process. On the other hand, analytics and Artificial Intelligence (AI) and Machine Learning (ML) teams within companies are demanding access to data for use in testing, training, and validating models. Balancing these competing interests may prove challenging to companies.

Certain embodiments described herein may provide tools, techniques, and/or methods for balancing the privacy of sensitive data with the utility value to different users in different roles at scale. Some embodiments, described herein enable the automatic and dynamic generation of one or more data privacy policies given the context of source data, one or more regulations that to be complied with, the role of the user accessing the data, and the geographic location of the user at any given time.

Specifically, given the contexts of a source data set, one or more data privacy regulations, one or more roles of individuals who need access to data, and/or one or more geographies from where the individuals with the specific roles will access the data, data may be observed, discovered, matched, and annotated with various attributes such as a label or tag that describes what a data element is (e.g., social security number, contact information, etc), a sensitivity classification (e.g., high, medium, low, or not sensitive), and/or the format of the data (e.g., US phone number, IPV4 IP address, etc.). Using privacy policy models or generic privacy policies, which are data source agnostic, a recommended data privacy policy specific to a particular data source may be generated that defines how the sensitive data in the source should be converted so it is safe yet useful.

Certain embodiments described herein may additionally, or alternatively, provide tools, techniques, and/or methods for implementing and deploying data privacy filters in a target environment. Data privacy filters may be executable instance of data privacy policies with additional context and intelligence related to the target environment and may be used to deliver protected data to end user applications upon request or persist protected data in a database, file, or object store, for subsequent use.

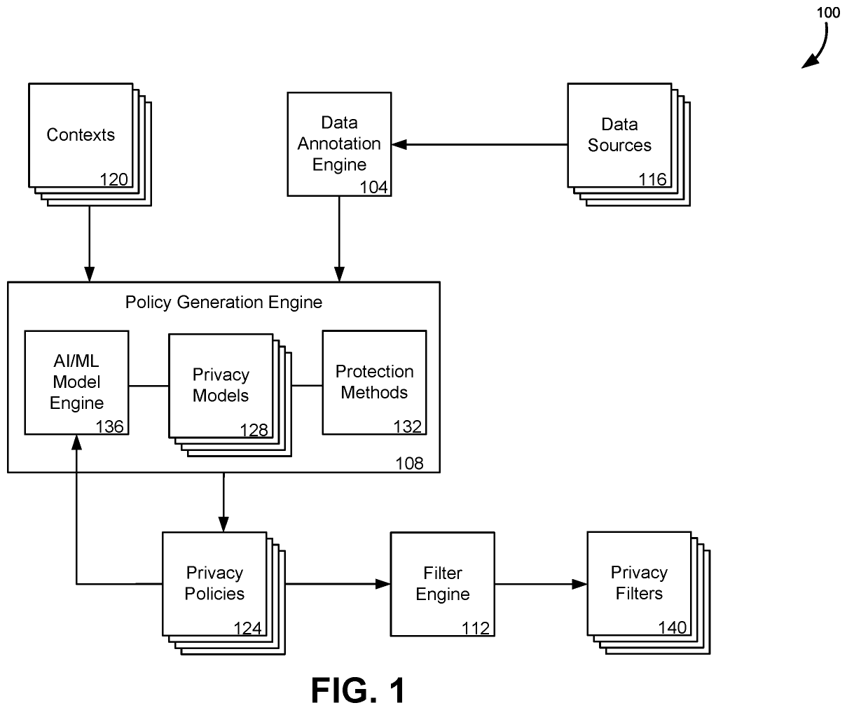

FIG. 1 illustrates a data privacy system 100 configured to generate data privacy policies and data privacy filters according to some embodiments. Data privacy system 100 may include one or more computer systems and/or software components configured to analyze the structure and/or contents of one or more collections of data and define policies for protecting potentially private data. As illustrated, data privacy system 100 includes one or more processing components, such as data annotation engine 104, policy generation engine 108, and filter engine 112, as described below. Data privacy system 100 may be connected with one or more external data and/or application systems. For example, data privacy system 100 may connect, via a network, with one or more physical and/or cloud-based data storage facilities. As another example, data privacy system 100 may connect with one or more physical and/or cloud-based application servers. Additionally, or alternatively, data privacy system 100, and/or one or more components of data privacy system 100, may be integrated as software applications into the external data storage and/or application services.

Data privacy system 100 may also include, have access to, and/or be communicatively coupled with, one or more sources of data, such as data sources 116. Data sources 116 may be a collection of tables, files, and/or objects in a database, file system, and/or object store with some structured or semi-structured set of columns and/or fields. For example, data sources 116 may include one or more relational or semi-relational databases. As another example, data sources 116 may include one or more file systems and/or directories.

Data sources 116 may store information pertaining to one or more entities and/or objects. For example, data sources 116 may include information about a plurality of individuals, such as in the case of an employee database, a customer database, a medical patient database and the like. As another example, data source 116 may include information about entities, such as businesses or organizations.

For each entity and/or object, data sources 116 may organize and/or store the information using fields common across multiple entities and/or objects. The fields may indicate the type, character, category, and/or content of information to be stored in data sources 116. For example, in a relational database, each column represented in a table may represent a type of information common to a number of entities and/or objects represented in the rows of the table. The values of the fields for each entity and/or object may necessitate varying degrees of protection depending on the degree of sensitivity of the information. For example, a person's first name may be less sensitive than that person's last name, and therefore may necessitate less protection compared with the persons last name or the combination of both names.

In some embodiments, data annotation engine 104 is configured to analyze the structure and/or content of data sources 116 and provide annotated data describing one or more attributes associated with each field of data sources 116. For example, as further described below, data annotation engine 104 may analyze the metadata of data sources 116 to determine, for each field, the type of data stored (e.g., the contents of each field in a database), the format of the data, and/or the degree of sensitivity. Additionally, or alternatively, data annotation engine 104 may include one or more classification engines used to classify the type of data in a data source. The type of data may be represented by a label or tag describing the particular data element. For example, if the type of a given field represents a person's personal identifier number (PID), such as an employee ID number, a patient ID number, a social security number (SSN) or the like, the associated label may be “PID” or “SSN”. The format of the data may indicate how the information is represented. For example, if the type of a given field is related to a person's birth date, the format may indicate whether the information is stored in one field and/or column (e.g., using a format similar to “month-date-year”), across multiple fields (e.g., separate fields for month, date, and year), using numbers only, using letters only, using an alphanumeric combination, or the like. As another example, if the type of a given field represents a phone number, the associated format may indicate whether the data is represented as a ten digit number (e.g., as is typical in the United States), a fifteen digit number (e.g., an international number), a four or five digit extension, and the like.

The degree of sensitivity may be a classification level selected from a list of sensitivity classifications levels. For example, the classification level may be “high”, “medium”, “low”, or “not sensitive”. Other classifications and/or ratings may be used to describe the degree of sensitivity for a field. For example, the degree of sensitivity may be represented by a letter grade (e.g., A, B, C, etc.), a percentage rating (e.g., 90%, 80%, 70%, etc.), and the like. Additionally, or alternatively, fields may be flagged for specific attributes, such as protected health information (PHI), or direct, indirect, or quasi identifiers, or simply labeled as “sensitive”. In some embodiments, the degree of sensitivity may indicate the level of protection, and/or methods of protection, to be applied to data. For example, data, and/or fields of data, with a sensitivity classification level of “high” may necessitate more stringent forms of protection than data with a sensitivity classification level of “medium” or “low”.

In some embodiments, the level and/or methods of protection depend on one or more contexts 120. Contexts 120 may be the purpose of use of the data and/or the geographical location in which the data will be used or accessed. The purpose of use of the data may include situations in which the data is used, or intended to be used. For example, data may be used for software testing, to obtain training data for artificial intelligence (AI) and/or machine learning (ML) models, for analysis by customer success teams, healthcare providers, finance teams, marketing teams, and the like. The purpose of use of the data may also include the functional role of a user accessing, or requesting access to, the data. For example, functional roles may be defined for company executives, individuals in marketing, finance, sales, engineering, quality assurance, and/or supply chain departments, and the like. Contexts 120 may also indicate one or more privacy regulations applicable to the data. Privacy regulations may include regulations or acts by a governmental body (e.g., a legislature, a regulatory agency, a governing body, etc.) laying out the framework and rules for protecting sensitive data in any data that a company collects, processes, manages, disseminates, and the like. In some embodiments, contexts 120 may be defined for each possible combination of intended use, role, and/or location of use. For example, a first context may be defined for an engineer training an AI/ML model in a first location, and a second context may be defined for the engineer training the AI/ML model in a second location. Contexts 120 may be extended to include any other dimension that may affect the appropriate protection of data, such as the time of use.

In some embodiments, contexts 120 are external definitions provided to data privacy system 100. For example, a user and/or an organization, may define one or more contexts using via a software application by filling in one or more fields via a user interface with data privacy system 100. Additionally, or alternatively, contexts 120 may be predefined and/or automatically generated by data privacy system 100 based on, for example, existing data privacy policies, regulations, company organization, business sectors, and the like.

In some embodiments, privacy policies 124 may be generated based on the annotated data from data annotation engine 104 and contexts 120. Privacy policies 124 may be a collection of protection methods prescribed for each field included in data sources 116. A protection method may be an actual technique by which raw data in a data source is converted to a protected form. This may be a function applied to raw data that changes the value and/or format of the data or removes/redacts the raw data altogether. Examples of different protection methods may include masking, tokenization, hashing, and a wide range of Privacy Enhancing Computation (PEC) methods, such as a differential privacy algorithm. Additionally, or alternatively, protection methods may use one or more generative AI models to produce synthetic data from the raw data. For example, privacy policies for datasets may be recommended, and privacy filters deployed, based on one or more types of Generative Adversarial Networks (GANs), such as CTGAN, WGAN, WGAN-GP, and the like.

Policy generation engine 108 may apply one or more generic privacy policies or privacy models 128 to the annotated data from data annotation engine 104 to generate privacy policies 124. Privacy models 128 may represent a set of rules laying out how different types of data that are sensitive within an organization should be protected based on an applicable context, as described above. For example, the set of rules may indicate which one or more protection methods of protection methods 132 to apply based on source data and an applicable context. Compared with privacy policies 124, privacy models 128 may be considered to be generic privacy policies, which are data source agnostic. In other words, privacy models 128 may be data source agnostic policies that define rules or guides for protecting classes or types of information regardless of the particular data source in which the information is stored. On the other hand, privacy policies 124 may be data source specific privacy policies including collections of protection methods derived from a data source agnostic policy for protecting information in a particular data source.

Privacy models 128 may be defined for a collection of labeled or tagged fields of the annotated data from data annotation engine 104. For example, privacy models 128 may include a unique set of rules laying out how, given a specific field of data, the field will be protected based on any applicable context. Additionally, or alternatively, privacy models 128 may be defined for each available context 120. For example, privacy models 128 may include a unique set of rules laying out how, given a specific context 120, each possible field of data is to be protected. For example, privacy models 128 may include a unique set of rules for each available context 120. Privacy models 128 may be organized in one or more forms, such as in rule sets, lookup tables, AI or ML models, and the like. In some embodiments, policy generation engine 108 uses application logic defined in privacy models 128 (e.g., “IF a AND b AND c THEN x”) to generate privacy policies 124.

In some embodiments, privacy models 128 include predefined rules codified by data privacy system 100. Additionally, or alternatively, privacy models 128 may be defined and/or updated by AI/ML model engine 136 based on previously generated and/or modified privacy policies 124. In some embodiments, data privacy system 100 enables users and/or organizations to override, correct, add, or update the recommended protection methods included in privacy policies 124. For example, after generating privacy policies 128, data privacy system 100 may display privacy policies 128 to a user for final review, modification, supplementation, and/or approval. At this point, a user may define different protection methods for various fields of a data source and/or implement complex logic, such as conditional logic, that the system may not recommend or otherwise be aware of in either privacy models 128 and/or protection methods 132.

In some embodiments, the reviewed and/or revised privacy policies 124 may then be provided to AI/ML model engine 136 for additional analysis and processing. Once received, AI/ML model engine 136 may identify one or more changes made to privacy policies 124 for a given context, and update privacy models 128 based on the one or more changes such that future privacy policies 124 generated for the given context, represent the intended purpose of the one or more changes. In some embodiments, AI/ML learning from reviewed and/or revised privacy policies 124 may occur within a given company or organization, across multiple companies in the same industry, across all available companies utilizing data privacy system 100 and/or any combination of companies. In the case where AI/ML learning is to occur across multiple companies/organizations, privacy policies 124 may be anonymized to preserve privacy of the individual data sets in each company's data sources 116.

In some embodiments, filter engine 112 generates one or more privacy filters 140 based on privacy policies 124. As described further below, privacy filters 140 may be an executable instance of a privacy policy. Privacy filters 140 may include additional context, such as a target environment in which it will run and data transformation monitoring and observability capabilities. Privacy filters 140 may be generated in a plurality of different forms such as a transformation function, External Function, or user defined function (UDF) in an extract, transform, and load (ETL) tool that may be pluggable into a data pipeline, a set of UDFs in a database or a Job executable via application programming interfaces (APIs) or via a designer tool user interface manually. Once deployed and/or implemented in a target environment, privacy filters 140 may transform, or otherwise provide protection for, data requested from data sources 116.

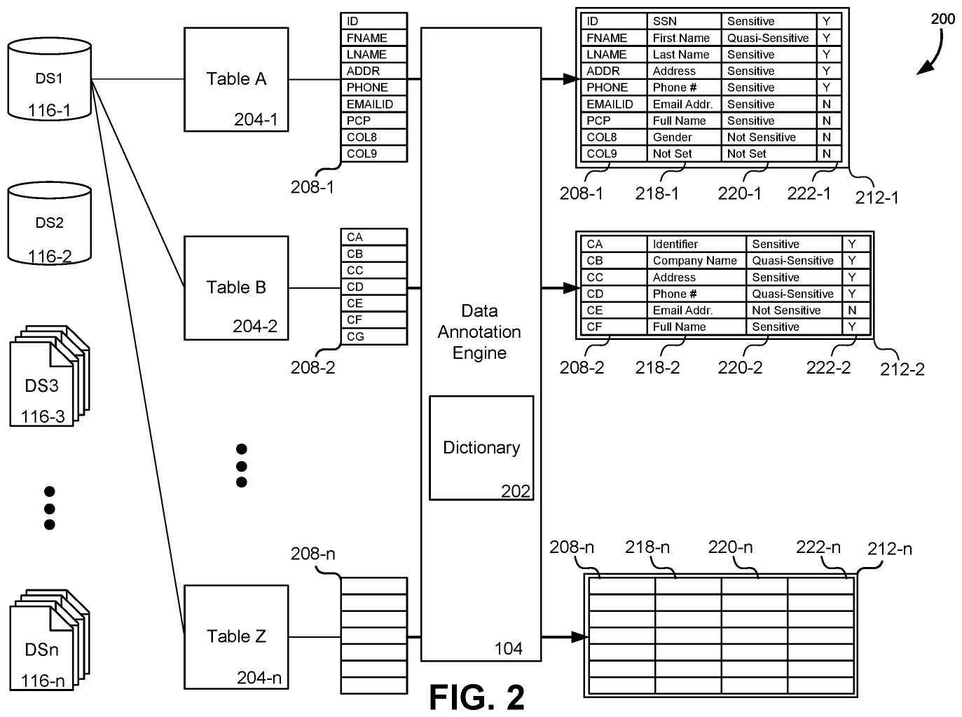

FIG. 2 illustrates a data privacy system 200 configured to annotate private data according to some embodiments. Data privacy system 200 may be the same, or function in a similar manner as data privacy system 100 described above. For example, as illustrated, data privacy system 200 includes data annotation engine 104 and data sources 116. As described above, data annotation engine 104 may be configured to analyze the structure and/or content of data sources 116 and provide annotated data 212 describing one or more attributes associated with each field of data sources 116. Data sources 116 may include one or more data stores of varying types. For example, as illustrated, data source 116-1 and data source 116-2 may each be databases, such as relational databases or object databases. As another example, data source 116-3 through data source 116-n may be files or file system directories or the like.

As illustrated, data source 116-1 may include a plurality of tables 204. Each of tables 204 may represent different combinations of information related to one or more entities and/or objects. For example, table A 204-1 may store information pertaining to individual persons while table B 204-2 may store information pertaining to companies or organizations. In some embodiments, information stored in one table may be linked to information stored in another table. For example, table A 204-1 may indicate a relationship between an individual and one or more companies or organizations stored in table B 204-2. Additionally, or alternatively, information pertaining to an entity or object may be distributed across multiple tables. For example, table A 204-1 may store basic information pertaining to individuals while table Z 204-n may store information related to purchases or services provided to an individual in table A 204-1. While described in relation to tabular data storage, other similar storage techniques may be used and/or analyzed according to various embodiments.

Each data source 116 may be associated with respective metadata 208 representing the organization and/or contents stored within the respective data source 116. Metadata 208 may include, for example, table definitions and/or column definitions, as in the case of a tabular database. Similarly, metadata 208 may include, for example, object definitions in the case of an object-oriented data store. In some embodiments, metadata 208 includes fields. Fields may correspond to column and/or object definitions. Information stored in data sources 116 may be organized and/or defined by fields. Fields may include titles, descriptions, labels and the like, used to describe, classify, characterize, and/or organize the information associated with any particular field. For example, as illustrated, metadata 208 may include the names of columns or fields in each respective table 204. For example, table A 204-1 may be represented by metadata 208-1, such as “ID”, “FName”, “LName”, etc, which may correspond to the columns in table A 204-1. As another example, table B 204-2 may be represented by metadata 208-2, such as “CA”, “CB”, “CC”, etc. In the case of files and/or file systems, metadata 208 may include machine readable and/or parseable headers or text elements in a file, file metadata, filename, and the like. In the case of object stores, fields may be indicated by object definitions and/or naming conventions.

Data annotation engine 104 may be configured to analyze metadata 208 associated with data sources 116 to provide annotated data 212. Annotated data 212 may include some or all information from metadata 208 as well as one or more additional attributes supplied by data annotation engine 104. The additional attributes may include labels, data format, degree of sensitivity, optional flags, and the like. For example, as illustrated, annotated data 212-1, generated from metadata 208-1, may include, for each field of metadata 208-1, labels 218-1, degrees of sensitivity 220-1, and optional flags 222-1. Labels 218-1 may be predefined labels used by data privacy system 200 to identify the type of information. For example, data annotation engine 104 may determine, based on the field “ID” in metadata 208-1, that the information stored in association with that field corresponds with an individual's SSN. Based on this determination, data annotation engine 104 may apply “SSN” as label 218-1 associated with field “ID” of metadata 208-1.

Additionally, or alternatively, data annotation engine 104 may analyze one or more data elements associated with a field to determine which attributes to apply to the field of metadata 208-1. For example, based on field “COL8” of metadata 208-1, data annotation engine 104 may be unable to determine the type of information stored in association with that particular field. Data annotation engine 104 may then proceed to analyze one or more data entries to determine the attributes to apply. For example, upon analyzing one or more entries associated with field “COL8” of metadata 208-1, data annotation engine 104 may determine that the entries are selected from either “male”, “female”, or “other”, and determine that the entries associated with field “COL8” of metadata 208-1 represent gender. Based on this determination, data annotation engine 104 may apply “gender” as label 218-1 associated with field “COL8” of metadata 208-1. In some embodiments, data annotation engine 104 can determine that a field is not associated with any actual data. For example, as illustrated, after determining that there is no information stored in association with field “COL9” of table A 204-1, data annotation engine 104 may apply “Not Set” as label 218-1 associated with field “COL9” of metadata 208-1.

Data annotation engine 104 may use dictionary 202 to determine the appropriate attributes to assign metadata 208. Dictionary 202 may include definitions for common fields observed across multiple data sources 116. For example, dictionary 202 may include an entry for individual's first names. The entry may be associated with the label “First Name” and may include other methods, expressions, models, or terms used to describe and recognize data fields storing an individual's first name, such as “FNAME”. By looking up “FNAME” in dictionary 202, data annotation engine 104 may identify the entry for individual's first names and determine that field “FNAME” of metadata 208-1 was used to represent individual's first names. Definitions in dictionary 202 may also include an indication of whether the information described by such a metadata field is sensitive and/or provide a sensitivity classification level for the field, as described above.

In some embodiments, dictionary 202 may be extensible. For example, dictionary 202 may be predefined for data privacy system 200. However, as data annotation engine 104 and/or data privacy system 200 observes additional metadata fields, dictionary 202 may be updated either manually, or via machine learning based on an analysis of the underlying data, to include additional entries, and/or to update existing entries. In some embodiments, external vocabularies and/or taxonomies are used to supplement, and/or function instead of, dictionary 202.

In some embodiments, data annotation engine 104 may also use contexts, such as contexts 120 described above, to generate annotated data 212. Depending on the context data annotation engine 104 may apply different attributes to data stored in data sources 116. For example, data annotation engine 104 may apply different degrees of sensitivity 220 to contact information for individuals depending on whether the intended use is for directed marketing purposes or for broad scale data analytics.

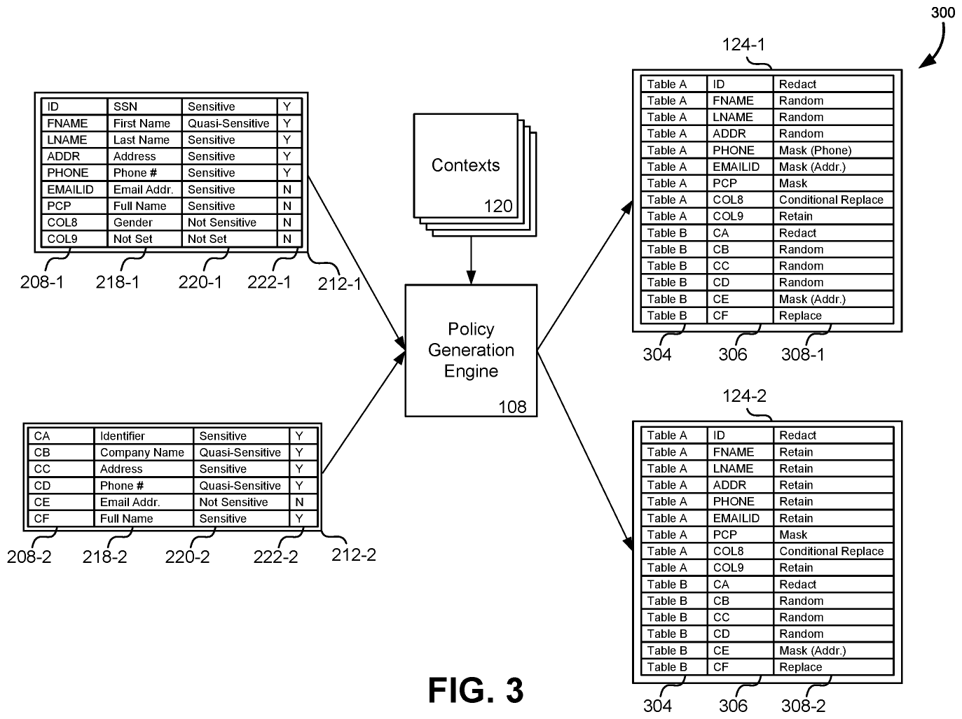

FIG. 3 illustrates a data privacy system 300 configured to generate context based data privacy policies according to some embodiments. Data privacy system 300 may be the same, or function in a similar manner as data privacy system 100 and/or data privacy system 200, as described above. For example, as illustrated, data privacy system 300 includes policy generation engine 108. As described above, policy generation engine 108 may generate one or more privacy policies 124 based on annotated data 212 provided by a data annotation engine, such as data annotation engine 104 described above, and contexts 120. Contexts 120 may include the same or similar information as described above in relation to FIG. 1. For example, each of contexts 120 may describe a combination of an intended use of data, a user role, a regulation, and/or a geographic location.

As further described above, privacy policies 124 may be a collection of protection methods 308 prescribed for each field 306 of data included in a data source. For example, as illustrated, privacy policy 124-1 may include a corresponding protection method 308-1 for each field 306 of each table 304 in a data source. Policy generation engine 108 may apply one or more privacy models, such as privacy models 128 described above, to assign the appropriate protection method based on any one or a combination of metadata 208, labels 218, degrees of sensitivity 220, optional flags 222, and/or the specific data format for a data field, of annotated data 212. For example, policy generation engine 108 may determine, based on an analysis of a particular privacy model defined for a given context, that the “ID” field in a data source identified as corresponding to an individual's SSN should be redacted, the “FNAME” field corresponding to an individual's first name should be randomized, etc.

In some embodiments, policy generation engine 108 may generate additional privacy policies 124 for each available context of contexts 120. For example, as illustrated, policy generation engine 108 may generate second privacy policy 124-2 from annotated data 212 for a different context than the context for which privacy policy 124-1 was generated. Privacy policies 124 generated based on different contexts 120 may include overlapping protection methods 308 for a given field 306 and/or a completely unique set of protection methods 308 for each field 306. For example, as illustrated, the assigned protection method for “ID” of “Redact” in privacy policy 124-1 may be the same in privacy policy 124-2. However, as another example, the assigned protection method for “FNAME” of “Random” in privacy policy 124-1 may be updated to “Retain” in privacy policy 124-2 for a different context.

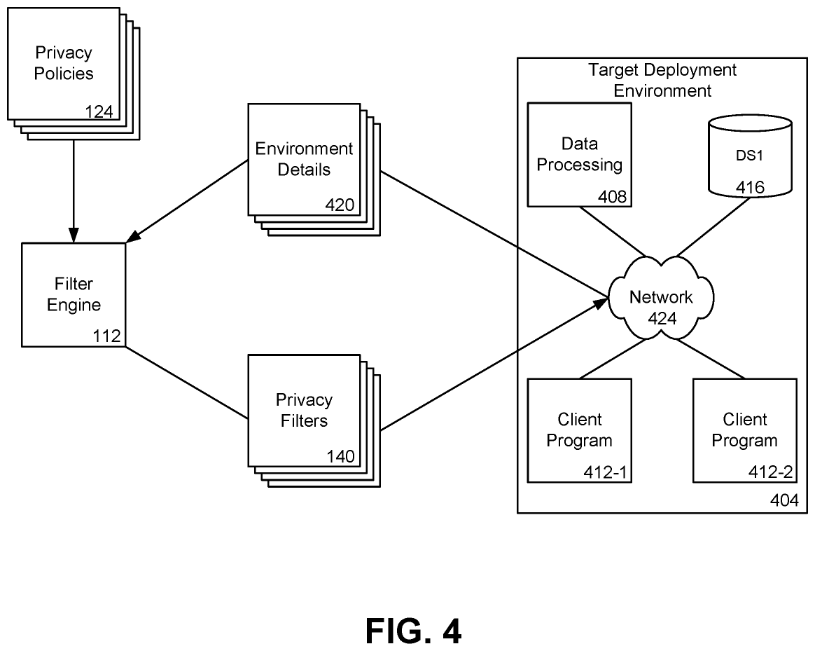

FIG. 4 illustrates the implementation and deployment of privacy policy based executable data privacy filters in a target environment according to some embodiments. As described further above, once a privacy policy has been generated, it may be deployed and/or implemented in a target environment, such as target deployment environment 404, to begin filtering and/or transforming data as specified by the privacy policy.

Target deployment environment 404 may include data processing 408, data source 416, one or more client programs 412, and network 424. Data source 416 may be the same, or function in a similar manner, as data sources 116 described above. For example, data source 416 may store information pertaining to one or more entities, individuals, and/or objects. Data source 416 may also include a target environment for transformed data. The target environment for transformed data may be a database, a real-time stream, a data pipeline, and the like. Data processing 408 may include one or more components configured to perform various functions such as retrieving, storing, and/or transforming the data of data source 416. Data processing 408 may include the environment in which privacy filters 140 will be executed. Privacy filters 140 may be run in different environments such as Snowflake, Apache Spark Data Pipeline, Kafka stream, and the like. In some embodiments, data processing 408 may be used to pushdown protection methods associated with privacy filters 140 into data source 416 as a UDF, or in other forms, so it may be executed closer to the data source.

Client programs 412 may include one or more software applications configured to request, display, analyze, and/or create, the data in data source 416. Client programs 412 may include end user applications. Data processing 408 and/or data source 416 may use privacy filters 140 to deliver protected data to client programs 412 via proxy access. In some embodiments, privacy filters 140 applied to requested data depend on the requesting client program. For example, a first set of privacy filters 140 may be applied for requests received from client program 412-1 while a different set of privacy filters 140 may be applied for requests received from client program 412-2. Client programs 412 may include one or more identifying features associated with corresponding contexts, as described above, which may be used to determine the appropriate privacy filter. For example, client program 412-1 may include information indicating the role of a user of client program 412-1 and/or an intended use of requested data by client program 412-1. Additionally, or alternatively, client programs 412 may indicate in which geographic location they are operating. For example, client program 412-1 may indicate that it is operating in a first geographic region associated with a first set of privacy regulations while client program 412-2 may indicate that it is operating in a second geographic region associated with a second set of privacy regulations.

In some embodiments, filter engine 112 may implement privacy filters 140 for a target environment based environment details 420 associated with the target environment. Environment details 420 may include information related to the target environment for the transformed data (e.g., database vs. real-time stream vs. data pipeline), the environment where the filter will run (e.g., Snowflake vs. Apache Spark Data Pipeline vs. Kafka Stream), and/or the form (or forms) which the filters will take (e.g., database UDFs vs. callable external functions vs. ETL transforms vs. ETL jobs). Target deployment environment 404 may provide environment details 420 to filter engine 112 before generation of privacy filters 140. Additionally, or alternatively, filter engine 112 may query target deployment environment 404 for environment details 420. In some embodiments, environment details 420 are provided by a user, such as a system administrator, to filter engine 112 upon installation and/or integration of the data privacy system including filter engine 112.

Once filter engine 112 has received and/or obtained privacy policies 124 and environment details 420, filter engine 112 may begin generating privacy filters 140. As described above, privacy filters 140 may be an executable instance of a privacy policy. For example, privacy filters 140 may include transformation functions or UDFs in an ETL tool, callable external functions that may be pluggable into a data pipeline, a set of UDFs in a database or a Job executable via application programming interfaces (APIs) or via a designer tool user interface manually. Additionally, or alternatively, privacy filters 140 may take the form of a package or model.

Filter engine 112 may proceed to deploy the generated privacy filters 140 within target deployment environment 404. Once deployed and/or implemented in a target environment, privacy filters 140 may transform, or otherwise provide protection for, data requested from data source 416. In some embodiments, deploying privacy filters 140 within target deployment environment 404 includes defining and/or setting up runtime details for privacy filters 140.

In some embodiments, filter engine 112, and/or a monitoring component of a data privacy system, such as data privacy system 100, may monitor the execution of privacy filters 140 within target deployment environment 404. For example, data transformed in response to a request from a client program, such as client programs 412, may be monitored and analyzed to ensure the appropriate protection methods are being applied to transform the requested data according to the particular context in which the data is requested. Privacy filters 140 may be monitored, and/or flagged, for anomalous behavior, such as applying inappropriate protection methods to requested data.

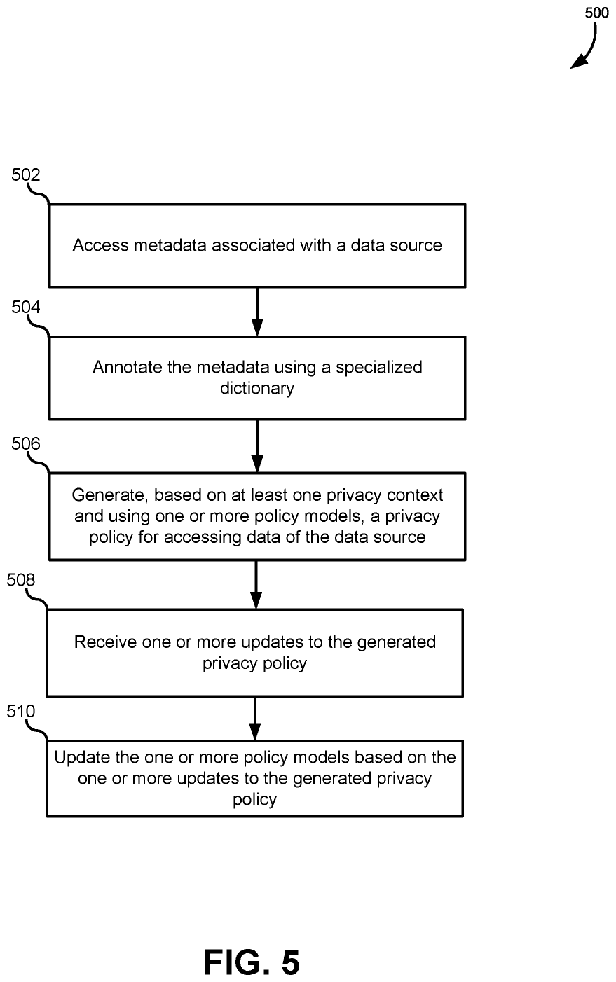

Various methods may be performed using the systems and configurations detailed in relation to FIGS. 1-4. FIG. 5 illustrates an exemplary method 500 of generating context-based data privacy policies according to some embodiments. In some embodiments, method 500 is performed by one or more components of a data privacy system, such as data privacy system 100 as described above. At block 502, metadata associated with a data source is accessed. The data source may be the same, or function in a similar manner as data sources 116 described above. For example, the data source may store information pertaining to one or more entities, individuals, and/or objects. The metadata may include the same or similar information as metadata 208 as described above. For example, the metadata may include the names and/or properties of each column in a tabular data source. The metadata may be accessed by a data annotation engine, such as data annotation engine 104 as described above.

At block 504, the metadata is annotated using a specialized dictionary. In some embodiments, a data annotation engine, such as data annotation engine 104 as described above, may create annotated data using a specialized dictionary, such as dictionary 202 as described above. For example, one or more attributes, such as a label, a data format, and the degree of sensitivity, may be associated with each field indicated by the metadata. In some embodiments, the specialized dictionary may be imported from other systems such as a data catalog or metadata repository. Additionally, or alternatively, the specialized dictionary may be custom created by a user. For example, a data privacy system, such as data privacy system 100, may include one or more user interfaces providing user editable fields, import and/or export capabilities, and the like.

At block 506, a privacy policy for accessing data of the data source is generated for each of one or more privacy contexts and using one or more policy models. The privacy policy may be the same, or function in a similar manner as, privacy policies 124 described above. For example, the privacy policy may be a collection of protection methods prescribed for each field included in the data source. The one or more privacy contexts may include the same, or similar information, as contexts 120 described above. For example, each of the one or more privacy contexts may indicate a purpose of use of the data, a role of the user of the data, a geographical location of the use of the data, and the like. The policy models may be the same, or function in a similar manner, as policy models 128 described above. For example, the policy models may include a set of rules indicating the appropriate protection method for a field of data given a privacy context. In some embodiments, a policy generation engine, such as policy generation engine 108 as described above, generates the privacy policies from the annotated metadata accessed from the data source, the privacy contexts, and one or more policy models defined for the privacy contexts.

At block 508, one or more updates to the generated privacy policy are received. In some embodiments, users and/or organizations may override, correct, add, or update the recommended protection methods included in the generated privacy policies. For example, after generating privacy policies, a data privacy system, such as data privacy system 100, may display the privacy policies to a user for final review, modification, supplementation, and/or approval. At this point, a user may define different protection methods for various fields of a data source and/or implement complex logic, such as conditional logic.

At block 510, the one or more policy models are updated based on the one or more updates to the generated privacy policy. In some embodiments, the reviewed and/or revised privacy police may be provided to an AI/ML model engine, such as AI/ML model engine 136 described above, for additional analysis and processing. Once received, an AI/ML model engine may identify one or more changes made to the privacy policy for the at least one privacy context and update the one or more privacy models based on the one or more changes such that future privacy policies generated for the at least one privacy context include the one or more changes.

It should be appreciated that the specific steps illustrated in FIG. 5 provide a particular method of generating context-based data privacy policies according to an embodiment of the present invention. Other sequences of steps may also be performed according to alternative embodiments. For example, alternative embodiments of the present invention may perform the steps outlined above in a different order. Moreover, the individual steps illustrated in FIG. 5 may include multiple sub-steps that may be performed in various sequences as appropriate to the individual step. Furthermore, additional steps may be added or removed depending on the particular applications. One of ordinary skill in the art would recognize many variations, modifications, and alternatives.

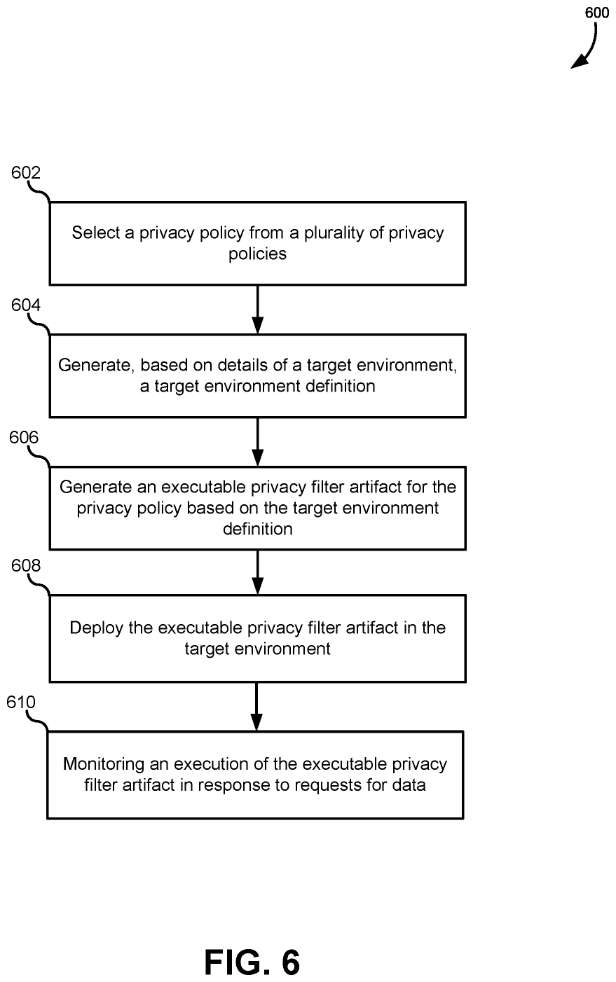

FIG. 6 illustrates an exemplary method of deploying and implementing policy-based data privacy filters according to some embodiments. In some embodiments, method 600 is performed by one or more components of a data privacy system, such as data privacy system 100 as described above, and/or a target environment, such as target deployment environment 404. At block 602, a privacy policy is selected form a plurality of privacy policies. The privacy policy may include the same, or similar information as, privacy policies 124 described above. For example, the privacy policy may be a collection of protection methods prescribed for each field included in a particular data source, such as data sources 116.

At block 604, a target environment definition is generated based on details of a target environment. The target environment may by the same, or function in a similar manner as, target deployment environment 404 as described above. For example, the target environment may include the data source, data processing capabilities, a network, and one or more client programs configured to access and/or manipulate data from the data source.

At block 606, an executable privacy filter artifact is generated for the selected privacy policy based on the target environment definition. The privacy filter artifact may be the same, or function in a similar manner as privacy filters 140 described above. For example, the privacy filter may be a transformation function or UDF in an ETL tool, a callable external function that may be pluggable into a data pipeline, a set of UDFs in a database or a ob executable via APIs or via a designer tool user interface manually.

At block 608, the executable privacy filter artifact is deployed in the target environment. A filter engine, such as filter engine 112 described above, may deploy the privacy filter artifact in the target environment. Deploying the privacy filter artifact may include setting up runtime details in the target environment for the privacy filter artifact. After deployment, at block 610, an execution of the executable privacy filter artifact is monitored in response to requests for data. For example, data provided in response to requests from a client program may be monitored to ensure the appropriate protection methods specified by the privacy policy are being applied correctly. In some embodiments, method 600 may optionally include flagging any anomalies in the data flow or transformations performed by the executable privacy filter artifact in response to requests for data.

It should be appreciated that the specific steps illustrated in FIG. 6 provide a particular method of deploying and implementing policy-based data privacy filters according to an embodiment of the present invention. Other sequences of steps may also be performed according to alternative embodiments. For example, alternative embodiments of the present invention may perform the steps outlined above in a different order. Moreover, the individual steps illustrated in FIG. 6 may include multiple sub-steps that may be performed in various sequences as appropriate to the individual step. Furthermore, additional steps may be added or removed depending on the particular applications. One of ordinary skill in the art would recognize many variations, modifications, and alternatives.

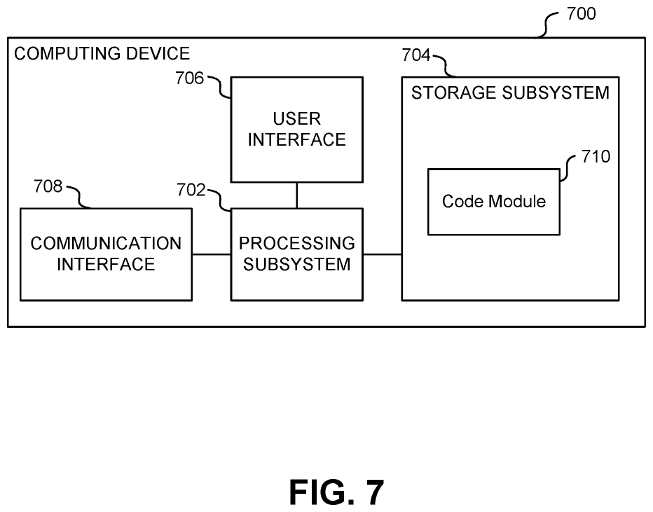

In some embodiments, one or more components of a data privacy system, such as data privacy system 100, and or one or more components of a target deployment environment, such as target deployment environment 404, are implemented on a computing device and/or in a computing system. FIG. 7 illustrates a block diagram of an embodiment of a computing device 700. Computing device 700 can implement some or all functions, behaviors, and/or capabilities described above that would use electronic storage or processing, as well as other functions, behaviors, or capabilities not expressly described. Computing device 700 includes a processing subsystem 702, a storage subsystem 704, a user interface 706, and/or a communication interface 708. Computing device 700 can also include other components (not explicitly shown) such as a battery, power controllers, and other components operable to provide various enhanced capabilities. In various embodiments, computing device 700 can be implemented in a desktop or laptop computer, mobile device (e.g., tablet computer, smart phone, mobile phone), wearable device, media device, application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, or electronic units designed to perform a function or combination of functions described above.

Storage subsystem 704 can be implemented using a local storage and/or removable storage medium, e.g., using disk, flash memory (e.g., secure digital card, universal serial bus flash drive), or any other non-transitory storage medium, or a combination of media, and can include volatile and/or nonvolatile storage media. Local storage can include random access memory (RAM), including dynamic RAM (DRAM), static RAM (SRAM), or battery backed up RAM. In some embodiments, storage subsystem 704 can store one or more applications and/or operating system programs to be executed by processing subsystem 702, including programs to implement some or all operations described above that would be performed using a computer. For example, storage subsystem 704 can store one or more code modules 710 for implementing one or more method steps described above.

A firmware and/or software implementation may be implemented with modules (e.g., procedures, functions, and so on). A machine-readable medium tangibly embodying instructions may be used in implementing methodologies described herein. Code modules 710 (e.g., instructions stored in memory) may be implemented within a processor or external to the processor. As used herein, the term “memory” refers to a type of long term, short term, volatile, nonvolatile, or other storage medium and is not to be limited to any particular type of memory or number of memories or type of media upon which memory is stored.

Moreover, the term “storage medium” or “storage device” may represent one or more memories for storing data, including read only memory (ROM), RAM, magnetic RAM, core memory, magnetic disk storage mediums, optical storage mediums, flash memory devices and/or other machine-readable mediums for storing information. The term “machine-readable medium” includes, but is not limited to, portable or fixed storage devices, optical storage devices, wireless channels, and/or various other storage mediums capable of storing instruction(s) and/or data.

Furthermore, embodiments may be implemented by hardware, software, scripting languages, firmware, middleware, microcode, hardware description languages, and/or any combination thereof. When implemented in software, firmware, middleware, scripting language, and/or microcode, program code or code segments to perform tasks may be stored in a machine-readable medium such as a storage medium. A code segment (e.g., code module 710) or machine-executable instruction may represent a procedure, a function, a subprogram, a program, a routine, a subroutine, a module, a software package, a script, a class, or a combination of instructions, data structures, and/or program statements. A code segment may be coupled to another code segment or a hardware circuit by passing and/or receiving information, data, arguments, parameters, and/or memory contents. Information, arguments, parameters, data, etc., may be passed, forwarded, or transmitted by suitable means including memory sharing, message passing, token passing, network transmission, etc.

Implementations of the techniques, blocks, steps and means described above may be done in various ways. For example, these techniques, blocks, steps and means may be implemented in hardware, software, or a combination thereof. For a hardware implementation, the processing units may be implemented within one or more ASICs, DSPs, DSPDs, PLDs, FPGAs, processors, controllers, micro-controllers, microprocessors, other electronic units designed to perform the functions described above, and/or a combination thereof.

Each code module 710 may comprise sets of instructions (codes) embodied on a computer-readable medium that directs a processor of a computing device 700 to perform corresponding actions. The instructions may be configured to run in sequential order, in parallel (such as under different processing threads), or in a combination thereof. After loading a code module 710 on a general purpose computer system, the general purpose computer is transformed into a special purpose computer system.

Computer programs incorporating various features described herein (e.g., in one or more code modules 710) may be encoded and stored on various computer readable storage media. Computer readable media encoded with the program code may be packaged with a compatible electronic device, or the program code may be provided separately from electronic devices (e.g., via Internet download or as a separately packaged computer readable storage medium). Storage subsystem 704 can also store information useful for establishing network connections using the communication interface 708.

User interface 706 can include input devices (e.g., touch pad, touch screen, scroll wheel, click wheel, dial, button, switch, keypad, microphone, etc.), as well as output devices (e.g., video screen, indicator lights, speakers, headphone jacks, virtual- or augmented-reality display, etc.), together with supporting electronics (e.g., digital to analog or analog to digital converters, signal processors, etc.). A user can operate input devices of user interface 706 to invoke the functionality of computing device 700 and can view and/or hear output from computing device 700 via output devices of user interface 706. For some embodiments, the user interface 706 might not be present (e.g., for a process using an ASIC).

Processing subsystem 702 can be implemented as one or more processors (e.g., integrated circuits, one or more single core or multi core microprocessors, microcontrollers, central processing unit, graphics processing unit, etc.). In operation, processing subsystem 702 can control the operation of computing device 700. In some embodiments, processing subsystem 702 can execute a variety of programs in response to program code and can maintain multiple concurrently executing programs or processes. At a given time, some or all of a program code to be executed can reside in processing subsystem 702 and/or in storage media, such as storage subsystem 704. Through programming, processing subsystem 702 can provide various functionality for computing device 700. Processing subsystem 702 can also execute other programs to control other functions of computing device 700, including programs that may be stored in storage subsystem 704.

Communication interface 708 can provide voice and/or data communication capability for computing device 700. In some embodiments, communication interface 708 can include radio frequency (RF) transceiver components for accessing wireless data networks (e.g., Wi-Fi network; 3G, 4G/LTE; etc.), mobile communication technologies, components for short range wireless communication (e.g., using Bluetooth communication standards, NFC, etc.), other components, or combinations of technologies. In some embodiments, communication interface 708 can provide wired connectivity (e.g., universal serial bus, Ethernet, universal asynchronous receiver/transmitter, etc.) in addition to, or in lieu of, a wireless interface. Communication interface 708 can be implemented using a combination of hardware (e.g., driver circuits, antennas, modulators/demodulators, encoders/decoders, and other analog and/or digital signal processing circuits) and software components. In some embodiments, communication interface 708 can support multiple communication channels concurrently. In some embodiments, the communication interface 708 is not used.

It will be appreciated that computing device 700 is illustrative and that variations and modifications are possible. A computing device can have various functionality not specifically described (e.g., voice communication via cellular telephone networks) and can include components appropriate to such functionality.

Further, while the computing device 700 is described with reference to particular blocks, it is to be understood that these blocks are defined for convenience of description and are not intended to imply a particular physical arrangement of component parts. For example, the processing subsystem 702, the storage subsystem 704, the user interface 706, and/or the communication interface 708 can be in one device or distributed among multiple devices.

Further, the blocks need not correspond to physically distinct components. Blocks can be configured to perform various operations, e.g., by programming a processor or providing appropriate control circuitry, and various blocks might or might not be reconfigurable depending on how an initial configuration is obtained. Embodiments of the present invention can be realized in a variety of apparatus including electronic devices implemented using a combination of circuitry and software. Electronic devices described herein can be implemented using computing device 700.

It is also understood that the examples and embodiments described herein are for illustrative purposes only and that various modifications or changes in light thereof will be suggested to persons skilled in the art and are to be included within the spirit and purview of this application and scope of the appended claims.

In the foregoing description, for the purposes of explanation, numerous specific details were set forth in order to provide a thorough understanding of various embodiments of the present invention. It will be apparent, however, to one skilled in the art that embodiments of the present invention may be practiced without some of these specific details. In other instances, well-known structures and devices are shown in block diagram form.

The foregoing description provides exemplary embodiments only, and is not intended to limit the scope, applicability, or configuration of the disclosure. Rather, the foregoing description of the exemplary embodiments will provide those skilled in the art with an enabling description for implementing an exemplary embodiment. It should be understood that various changes may be made in the function and arrangement of elements without departing from the spirit and scope of the invention as set forth in the appended claims.

Specific details are given in the foregoing description to provide a thorough understanding of the embodiments. However, it will be understood by one of ordinary skill in the art that the embodiments may be practiced without these specific details. For example, circuits, systems, networks, processes, and other components may have been shown as components in block diagram form in order not to obscure the embodiments in unnecessary detail. In other instances, well-known circuits, processes, algorithms, structures, and techniques may have been shown without unnecessary detail in order to avoid obscuring the embodiments.

Also, it is noted that individual embodiments may have been described as a process which is depicted as a flowchart, a flow diagram, a data flow diagram, a structure diagram, or a block diagram. Although a flowchart may have described the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

The term “computer-readable medium” includes, but is not limited to portable or fixed storage devices, optical storage devices, wireless channels and various other mediums capable of storing, containing, or carrying instruction(s) and/or data. A code segment or machine-executable instructions may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc., may be passed, forwarded, or transmitted via any suitable means including memory sharing, message passing, token passing, network transmission, etc.

Furthermore, embodiments may be implemented by hardware, software, firmware, middleware, microcode, hardware description languages, or any combination thereof. When implemented in software, firmware, middleware or microcode, the program code or code segments to perform the necessary tasks may be stored in a machine readable medium. A processor(s) may perform the necessary tasks.

In the foregoing specification, aspects of the invention are described with reference to specific embodiments thereof, but those skilled in the art will recognize that the invention is not limited thereto. Various features and aspects of the above-described invention may be used individually or jointly. Further, embodiments can be utilized in any number of environments and applications beyond those described herein without departing from the broader spirit and scope of the specification. The specification and drawings are, accordingly, to be regarded as illustrative rather than restrictive.

Additionally, for the purposes of illustration, methods were described in a particular order. It should be appreciated that in alternate embodiments, the methods may be performed in a different order than that described. It should also be appreciated that the methods described above may be performed by hardware components or may be embodied in sequences of machine-executable instructions, which may be used to cause a machine, such as a general-purpose or special-purpose processor or logic circuits programmed with the instructions to perform the methods. These machine-executable instructions may be stored on one or more machine readable mediums, such as CD-ROMs or other type of optical disks, floppy diskettes, ROMs, RAMs, EPROMs, EEPROMs, magnetic or optical cards, flash memory, or other types of machine-readable mediums suitable for storing electronic instructions. Alternatively, the methods may be performed by a combination of hardware and software.

What is claimed is:

1. A method of generating privacy policies, the method comprising:
obtaining metadata associated with a data source, raw data from the data source, or both, wherein the metadata represents an organization of the raw data by the data source into one or more fields;
selecting attributes to describe each field of the one or more fields based on the metadata, the raw data, or both to produce annotated metadata associated with the data source;
determining a context in which the raw data will be accessed from the data source; and
generating a privacy policy for protecting access to the raw data in the context by applying a privacy model defined for the context to the annotated metadata.

2. The method of claim 1, wherein the attributes for a field are selected from categories comprising a type category indicating a class of information represented by the raw data stored in the field, a format category indicating how the information is represented in the raw data, and a sensitivity category indicating a degree of sensitivity associated with the information.

3. The method of claim 1, wherein one or more of the attributes are selected based on the context in which the raw data will be accessed.

4. The method of claim 1, wherein the context comprises a first combination of an intended use of the raw data, a regulation, a functional role of a user who will access the raw data, and a geographical location from which the raw data will be accessed.

5. The method of claim 4, further comprising:
determining a plurality of potential contexts in which the raw data will be accessed including the context, wherein each context of the plurality of potential contexts comprises a different combination of the intended use, the regulation, the functional role, and the geographical location compared to the first combination; and
generating a plurality of privacy policies for each content of the plurality of potential contexts.

6. The method of claim 1, wherein the privacy policy comprises protection methods prescribed for each field of the one or more fields for protecting the raw data upon access in the context.

7. The method of claim 6, wherein, in response to accessing the raw data from the data source in the context, the protection methods automatically transform the raw data into a protected form by either changing values of the raw data, redacting the values of the raw data, or both.

8. The method of claim 1, further comprising:
displaying the privacy policy to a user; and
modifying the privacy policy in response to one or more interactions from the user to produce a modified privacy policy.

9. The method of claim 8, further comprising:
receiving the modified privacy policy; and
modifying the privacy model based on differences between the privacy policy and the modified privacy policy.

10. The method of claim 1, wherein the data source is included in a target environment and the method further comprises:
generating an executable privacy filter based on the privacy policy and the target environment;
deploying the executable privacy filter within the target environment;
receiving a request for a subset of the raw data in the data source; and
retrieving, by the executable privacy filter, the subset of the raw data in a protected form in response to receiving the request.

11. One or more non-transitory computer readable media comprising instructions that, when executed by one or more processors, cause the one or more processors to perform operations comprising:
obtaining metadata associated with a data source, raw data from the data source, or both, wherein the metadata represents an organization of raw data by the data source into one or more fields;
selecting attributes to describe each field of the one or more fields based on the metadata, the raw data, or both to produce annotated metadata associated with the data source;
determining a context in which the raw data will be accessed from the data source; and
generating a privacy policy for protecting access to the raw data in the context by applying a privacy model defined for the context to the annotated metadata.

12. A method of deploying a privacy filter in a target environment, the method comprising:
selecting a first privacy policy from a plurality of privacy policies generated for protecting raw data in a data source;
generating a definition for a target computing environment based on details obtained for a computing environment comprising the data source;
generating, based on the definition, an executable instance of the first privacy policy for the target computing environment; and
deploying the executable instance of the first privacy policy within the target computing environment.

13. The method of claim 12, wherein the executable instance of the first privacy policy is configured to transform the raw data into a protected form in response to a request to access the raw data in the data source.

14. The method of claim 13, further comprising:
monitoring a transformation of the raw data into the protected form by the executable instance of the first privacy policy to produce protected data; and
detecting an anomaly in the transformation based on the protected data.

15. The method of claim 12, wherein each privacy policy of the plurality of privacy policies is generated for a corresponding context of a plurality of contexts in which the raw data will be accessed and the method further comprises generating a plurality of executable instances for each privacy policy of the plurality of privacy policies.

16. The method of claim 15, wherein the executable instance of the first privacy policy is selected from the plurality of executable instances in response to a request to access the raw data in the data source from a client program with a context that corresponds to the first privacy policy.

17. The method of claim 12, wherein the executable instance of the first privacy policy comprises one or more transformation functions configured to transform a raw value in a field of the raw data by either changing the raw value to a new value, redacting the raw value, or both.

18. The method of claim 12, wherein the executable instance of the first privacy policy comprises a model trained by one or more Generative Adversarial Networks using training data to generate synthetic data.

19. The method of claim 12, wherein the definition for the target computing environment comprises information about the data source, a transformed data source, a processing resource by which the executable instance will be executed, and an intended form of the executable instance.

20. The method of claim 12, further comprising:
generating, based on a second definition for a second target computing environment, a second executable instance of the first privacy policy; and
deploying the second executable instance of the first privacy policy within the second target computing environment.
